(19) United States
(12) Patent Application Publication
(10) Pub. No.: US 2016/0174187 A1
(43) Pub. Date: Jun. 16, 2016

(54) System and Methods for Enhancing Data Throughput and Page Performance in a Multi-SIM Wireless Communication Device

(71) Applicant: QUALCOMM Incorporated, San Diego, CA (US)

(72) Inventors: Rajesh Gopala Krishnan, Hyderabad (IN); Dhananjaya Sarma Ponukumati, Hyderabad (IN)

(21) Appl. No.: 14/569,863

(22) Filed: Dec. 15, 2014

(51) Int. Cl. H04W 68/02; H04W 76/04; H04W 52/04; H04B 1/3816; H04W 74/08

(52) U.S. Cl. CPC H04W 68/02; H04B 1/3816; H04W 74/0833; H04W 52/04; H04W 76/046

(57) ABSTRACT

Methods and devices for improving data throughput and page performance of a multi-subscription wireless communication device with a shared radio frequency (RF) resource may include detecting when a random access channel (RACH) procedure required on a modem stack associated with the first SIM in order to access a first network will coincide with a scheduled tune-away period for the shared RF resource corresponding to a reservation for activity on a second network supported by the second SIM. When such coincidence is detected, the wireless communication device may periodically transmit preambles to the first network with increasing transmission power until an acknowledgment is received or the scheduled tune-away period starts. When the scheduled tune-away period starts, the wireless communication device may pause transmission of preambles and record virtual preambles. When the tune-away period ends, the wireless communication device may continue the RACH procedure based on actual and virtual preambles.

### BACKGROUND

Multi-subscriber identity module (SIM) wireless devices have become increasing popular because of their flexibility in service options and other features. One type of multi-SIM wireless device, a dual-SIM dual-standby (DSDS) device, enables both SIMs to be in idle mode waiting to begin communications, but only allows one SIM at a time to participate in an active communication due to sharing of a single radio frequency (RF) resource (e.g., transceiver). Other multi-SIM devices may extend this capability to more than two SIMs, and may be configured with any number of SIMs greater than two (i.e., multi-SIM multi-standby wireless devices)

Wireless communication networks are widely deployed to provide various communication services such as telephony, video, data, messaging, broadcasts, and so on. Such networks, which are usually multiple access networks, support communications for multiple users by sharing the available network resources. One example of such a network is the UMTS Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). The UMTS also supports enhanced 3G data communications protocols, such as High Speed Packet Access (HSPA), which provides higher data transfer speeds and capacity to associated UMTS networks.

Multi-SIM wireless devices can have multiple subscriptions to one or more wireless networks. For example, in a DSDS device, a first subscription may support networks using a first technology standard, such as Wideband Code Division Multiple Access (WCDMA), while a second subscription may support a second technology standard, such as Global System for Mobile Communications (GSM) Enhanced Data rates for GSM Evolution (EDGE) (also referred to as GERAN). Since the DSDS device typically uses a single RF resource to communicate over the multiple SIMs and/or networks, the wireless device can only actively communicate using a single SIM and/or network at a given time. As such, using an active communication using one SIM (e.g., the first SIM), the wireless device may periodically tune away to a network associated with another SIM (e.g., the second SIM) to monitor signals or acquire a connection.

During such tune-aways, the wireless device may lose the downlink information on the active communication, and typically cancels any ongoing uplink communication since the RF resource is temporarily unavailable. However, certain channel structures that may be used to set up or form the active communication on the first SIM frequently result in frequency conflicts with the tune-aways to the network associated with the second SIM. Specifically, for transmissions on the random access channel (RACH), which are un-scheduled and subject to contention-based access, multiple access attempts/retransmissions are generally expected. In some cases, a majority of the tune-aways to the network associated with the second SIM may conflict with at least one transmission on the RACH or attempt to access the RACH. As a result, a trade-off may be created between the ability to perform page decodes on the network associated with the second SIM and the quality/speed of the communication on the network associated with the first SIM.

### SUMMARY

Systems, methods, and devices of various embodiments may enable a wireless communication device configured to use at least a first subscriber identity module (SIM) and a second SIM associated with a shared radio frequency (RF) resource to improve data throughput and page performance by detecting that a random access channel (RACH) transmission is required on a modem stack associated with the first SIM in order to access a first network supported by the first SIM, transmitting a first preamble to the first network using the shared RF resource, identifying a scheduled tune-away period for the shared RF resource, monitoring for reception of an acknowledgment for the modem stack associated with the first SIM, transmitting additional preambles to the first network while the acknowledgment has not been received, and determining whether the scheduled tune-away period has started. If the scheduled tune-away period has started, embodiment methods may also include pausing transmission of the additional preambles, and recording virtual preambles for the first network. In some embodiments, the preamble may be transmitted on a physical RACH (PRACH) at an initial transmission power. In some embodiments, the scheduled tune-away period may correspond to a reservation for activity on a second network supported by the second SIM. In some embodiments, the reservation for activity on the second network may be a page decode time for the second SIM. In some embodiments, monitoring for reception of an acknowledgment includes monitoring the acquisition indicator channel (AICH), in which the acknowledgment is an acquisition indicator (AI). In some embodiments each additional preamble may have a transmission power equal to a sum of a preceding preamble transmission power and a power increment value.

Embodiment methods may also include determining whether the scheduled tune-away period has ended, stopping recording of the virtual preambles in response to determining that the scheduled tune-away period has ended, and resuming the transmission of additional preambles based on the recorded virtual preambles from the tune-away period. In some embodiments, the preceding preamble transmission power may be a power value corresponding to a more recent of a last transmitted additional preamble and a last recorded virtual preamble. In some embodiments, recording the virtual preambles for the first network may include, for each virtual preamble, waiting a predetermined period of time and recording a transmission power. In some embodiments, the transmission power includes a sum of the power increment value and a power value corresponding to a more recent of a last transmitted additional preamble and a last recorded virtual preamble. In some embodiments, the initial transmission power, the power increment value, and the predetermined period of time may be identified in system information received from a base station of the first network.

Embodiment methods may also include determining whether an acknowledgement for the modem stack associated with the first SIM is received prior to the scheduled tune-away period, calculating an overhead time for the received acknowledgement in response to determining that an acknowledgement for the modem stack associated with the first SIM is received prior to the tune-away period, and determining whether the calculated overhead time is longer than the time required to transmit the RACH message to the first network. In some embodiments, the overhead time may be a duration of time between the received acknowledgement and a start of the scheduled tune-away period. In some embodiments, the time required to transmit the RACH message to the first network may be one of 10 ms and 20 ms.

Embodiment methods may also include sending the RACH message to the first network before the start of the scheduled tune-away period in response to determining that the calculated overhead time is longer than the time required to transmit the RACH message to the first network. Embodiment methods may also include ignoring the received acknowledgement in response to determining that the calculated overhead time is longer than the time required to transmit the RACH message to the first network. In some embodiments, detecting that a RACH is required to access the first network supported by the first SIM on the modem stack associated with the first SIM may include detecting that a radio resource control (RRC) connection setup is requested on a modem stack associated with the first SIM. In some embodiments, detecting that a RACH is required to access the first network supported by the first SIM on the modem stack associated with the first SIM may include detecting that data needs to be sent to the modem stack associated with the first SIM, and detecting that a dedicated physical channel in an uplink is not allocated to the first SIM.

Embodiment methods may also include determining, based on a count of the transmitted first and additional preambles, whether a maximum number of permitted preamble transmissions has been reached, and stopping transmission of additional preambles in response to determining that the maximum number of permitted preamble transmissions has been reached. In some embodiments, the maximum number of permitted preamble transmissions may be identified from system information received from the base station of the first network.

Various embodiments include a wireless communication device including a wireless communication device configured to use at least a first subscriber identity module (SIM) and a second SIM associated with a shared radio frequency (RF) resource, and a processor configured with processor-executable instructions to perform operations of the methods described above. Various embodiments also include a non-transitory processor-readable medium on which are stored processor-executable instructions configured to cause a processor of a wireless communication device to perform operations of the methods described above. Various embodiments also include a wireless communication device having means for performing functions of the methods described above.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is a communication system block diagram of a network suitable for use with various embodiments.

FIG. 2A is a block diagram illustrating a wireless communications device according to various embodiments.

FIG. 2B is a system architecture diagram illustrating example protocol layer stacks implemented by the wireless communication device of FIG. 2A.

FIGS. 3A and 3B are illustrations of representative timelines of activity on a shared radio frequency (RF) resource of a dual SIM wireless communication device according to various embodiments.

FIGS. 4A and 4B are process flow diagrams illustrating a method for using an adaptive RACH procedure to improve data throughput and page performance of different SIMs on a multi-SIM wireless communication device according to various embodiments.

FIG. 5 is a process flow diagram illustrating an example method for performing the adaptive RACH procedure implemented in FIGS. 4A and 4B according to various embodiments.

FIG. 6 is a component diagram of an example wireless communication device suitable for use with various embodiments.

FIG. 7 is a component diagram of another example wireless communication device suitable for use with various embodiments.

### DETAILED DESCRIPTION

Various embodiments will be described in detail with reference to the accompanying drawings. Wherever possible the same reference numbers will be used throughout the drawings to refer to the same or like parts. References made to particular examples and implementations are for illustrative purposes, and are not intended to limit the scope of the invention or the claims.

The various embodiments provide methods and apparatuses for improving performance of communications associated with different SIMs in a wireless device configured with a shared RF resource. In particular, the various embodiments may enhance data throughput and round-trip-time (RTT) for uplink transmission on a first SIM without degrading the periodic tune-away for decoding the paging channel of a network associated with the second SIM.

In some wireless communication devices, a random access channel (RACH) procedure may be used to achieve access on a RACH in order to send data to a network associated with the first SIM. The RACH procedure may include a preamble cycle and RACH message, both of which involve transmissions on a physical RACH (PRACH). The preamble cycle may involve sending a trial transmission burst (“preamble”) to the network associated with the first SIM, and repeating the burst at a higher transmission power if no positive acknowledgement is received from the network (i.e., open-loop power control). In conventional wireless communication devices, when the RACH procedure at least partially overlaps a scheduled tune-away period for a network associated with the second SIM, the ongoing RACH procedure is cancelled and a back-off timer is triggered by a second layer of the modem stack associated with the first SIM (e.g., MAC layer, data link layer, L2, etc.). Following expiration of the back-off timer, the wireless device again attempts to access the network associated with first SIM. While this conventional solution resolves the conflict between the RACH procedure and the tune-away, the back-off timer typically introduces a delay that can last hundreds of milliseconds (e.g., 300 ms). Given the high rate of overlap that may exist between a tune-away period and an uplink transmission in the RACH process, such cancellation and delay may significantly impact the communication on the network associated with the first SIM.

The various embodiments provide methods of avoiding such cancellation and back-off time for the RACH procedure on the network associated with the first SIM when the RACH procedure conflicts with a page decode scheduled for the network associated with the second SIM. To avoid such conflicts, in various embodiments, the wireless device may pause the physical layer transmission activity in the ongoing RACH procedure for the duration of the tune-away period. Since the RACH procedure may involve many preamble repetitions before a positive acknowledgement (i.e., acquisition indicator) is received from the network, pausing the ongoing RACH procedure may frequently occur during the RACH preamble cycle. That is, the paused activity may involve transmission/retransmission of a preamble in access slots of a physical RACH (PRACH) at an incrementally increasing power level.

In various embodiments, during the tune-away period the wireless device may continue incremental power step-ups that would ordinarily be applied to preambles retransmissions by tracking and recording such power increases as “virtual preambles.” In this manner, the wireless device may efficiently continue to perform part of the RACH procedure during the tune-away, rather than resuming from the paused transmission power once the physical layer activity is resumed. That is, the wireless device may resume preamble retransmissions at the same heightened power level that would exist if the incremental power step-ups had been applied to actual transmissions (i.e., if the tune-away had not occurred). Further, by pausing the physical layer activity instead of cancelling the entire RACH procedure, the wireless device may avoid the long back-off timer that would ordinarily be triggered by the data link layer to delay the start of a new RACH procedure.

The terms “wireless device,” “wireless communication device,” “user equipment,” and “mobile device” are used interchangeably herein to refer to any one or all of cellular telephones, smart phones, personal or mobile multi-media players, personal data assistants (PDAs), laptop computers, tablet computers, smart books, palm-top computers, wireless electronic mail receivers, multimedia Internet enabled cellular telephones, wireless gaming controllers, and similar personal electronic devices that include a programmable processor and memory and circuitry for establishing wireless communication pathways and transmitting/receiving data via wireless communication pathways.

As used herein, the terms “subscription,” “SIM,” “SIM card,” and “subscriber identification module” are used interchangeably to mean a memory that may be an integrated circuit or embedded into a removable card, which stores an International Mobile Subscriber Identity (IMSI), related key, and/or other information used to identify and/or authenticate a wireless device on a network. Examples of SIMs include the Universal Subscriber Identity Module (USIM) provided for in the LTE 3GPP standard, and the Removable User Identity Module (R-UIM) provided for in the 3GPP2 standard. Universal Integrated Circuit Card (UICC) is another term for SIM.

The terms subscription and SIM may also be used as shorthand reference to a communication network associated with a particular SIM, since the information stored in a SIM enables the wireless device to establish a communication link with a particular network, thus the SIM and the communication network, as well as the services and subscriptions supported by that network, correlate to one another.

As used herein, the terms “multi-SIM wireless communication device,” “multi-SIM wireless device,” “dual-SIM wireless communication device,” “dual-SIM dual-standby device,” and “DSDS device” are used interchangeably to describe a wireless device that is configured with more than one SIM and allows idle-mode operations to be performed on two networks simultaneously, a well as selective communication on one network while performing idle-mode operations on the other network.

As used herein, the terms “power-saving mode,” “power-saving-mode cycle,” “discontinuous reception,” and “DRX cycle” are used interchangeably to refer to an idle-mode process that involves alternating sleep periods (during which power consumption is minimized) and awake (or “wake-up”) periods (in which normal power consumption and reception are returned and the wireless device monitors a channel by normal reception). The length of a power-saving-mode cycle, measured as the interval between the start of a wake-up period and the start of the next wake-up period, is typically signaled by the network.

Wireless communication networks are widely deployed to provide various communication services such as telephony, video, data, messaging, broadcasts, and so on. Such networks, which are usually multiple access networks, support communications for multiple users by sharing the available network resources. One example of such a network is the UMTS Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). The UMTS also supports enhanced 3G data communications protocols, such as High Speed Packet Access (HSPA), which provides higher data transfer speeds and capacity to associated UMTS networks.

In some wireless networks, a wireless communication device may have multiple subscriptions to one or more networks (e.g., by employing multiple subscriber identity module (SIM) cards or otherwise). Such a wireless device may include, but is not limited to, a dual-SIM dual-standby (DSDS) device. For example, a first subscription may be a first technology standard, such as Wideband Code Division Multiple Access (WCDMA), while a second subscription may support the same technology standard or a second technology standard, such as Global System for Mobile Communications (GSM) Enhanced Data rates for GSM Evolution (EDGE) (also referred to as GERAN).

A multi-SIM wireless device that supports two or more SIM cards may have a number of capabilities that provide convenience to a user, such as allowing different wireless carriers, plans, telephone numbers, billing accounts, etc. on one device. Developments in multi-SIM wireless communication device technology have led to a variety of different options for such devices. For example, an “active dual-SIM” wireless device allows two SIMs to remain active and accessible to the device. In particular, a type of active dual-SIM wireless communication device may be a “dual-active dual standby” (DSDS) wireless device in which two SIMs are configured to share a single transceiver (i.e., RF resource).

In operation, once powered on and/or recovering from an out-of-service condition, a conventional wireless device (or modem stack associated with a SIM of a conventional multi-SIM wireless device) may begin an initial cell selection procedure if no information about the current wireless environment is stored in the wireless device. Otherwise, the wireless device typically starts a cell selection using a stored information cell-selection procedure. The wireless device may have stored the necessary information of the cell (such as frequency and scrambling code) when the wireless device was previously camped on the cell. Generally, the wireless device may first try to synchronize with that previous cell, and if synchronization fails, the wireless communication device may trigger the initial cell selection.

A conventional wireless device may first attempt to find PLMNs for one or more radio access technology (e.g., UMTS). To find PLMNs, the wireless device may perform a power scan on enabled frequency bands supported by the radio access technology to identify channels and measure signal strength for identified channels. The wireless device may identify those channels that are above a threshold signal strength and may attempt acquisition of each identified strong channel. Acquisition of a UMTS channel may involve detecting a carrier frequency by searching for a primary synchronization code (PSC) sequence sent on a primary synchronization channel (SCH) for an identified strong channel, such as by correlating received samples with a locally generated PSC sequence at different time offsets. Alternatively, the wireless device may use a list of stored carrier frequency information from previously received measurement and control information. In UMTS systems, such information includes scrambling code.

For each detected carrier frequency (i.e., acquired cell), the wireless device typically tunes to the frequency to read information to identify the associated network. For example, in UMTS systems, the wireless device typically correlates the signal of the detected carrier frequency (i.e., acquired cell) to possible secondary synchronization codes to determine the correct code and obtain the frame synchronization on the corresponding secondary synchronization channel (S-SCH) and group identity, finds the correct scrambling code, and detects the common control physical channel (CCPCH), which carries the system information including PLMN. In this manner, the wireless device may identify acquired cells in the wireless device's vicinity.

A conventional wireless device may select one of the PLMNs from those identified according to either an automatic mode or a manual mode. Once a PLMN has been selected, the wireless device may read system information of each acquired cell to obtain parameters, such as the PLMN identity and cell selection parameters. Such system information may also include RACH-related information, which may be read from the broadcast channel (BCH) and used in order to access RACH in performing any of a number of procedures. Such procedures may include, for example, a transition between radio resource control (RRC) states (e.g., from CELL_FACH to CELL_DCH or CELL_PCH state, etc.), an initial call setup, a short message service message, etc.

For clarity, while the techniques and embodiments described herein relate to a wireless device configured with at least one WCDMA/UMTS SIM and/or GSM SIM, the embodiment techniques may be extended to subscriptions on other radio access networks (e.g., 1×RTT/CDMA2000, EVDO, LTE, WiMAX, Wi-Fi, etc.). In that regard, the messages, physical and transport channels, radio control states, etc. referred to herein may also be known by other terms in various radio access technologies and standards. Further, the messages, channels and control states may be associated with different timing in other radio access technologies and standards.

In various embodiments, an RF resource of a DSDS device may be configured to be shared between a plurality of SIMs, but may be employed by default to perform communications on a network enabled by a first SIM, such as a network capable of high-speed data communications (e.g., WCDMA, HSDPA, LTE, etc.). As such, a modem stack associated with a second SIM of the device may often be in idle mode with respect to a second network. Depending on the radio access technology of the second network, such idle mode states may involve implementing a power saving mode that includes a cycle of sleep and awake states. For example, if the second network is a GSM network, during idle mode the modem stack associated with the second SIM may implement discontinuous reception (DRX).

Specifically, during a wake-up period (i.e., awake state), the timing of which may be set by the second network for a paging group to which the second SIM belongs. The modem stack associated with the second SIM may attempt to use the shared RF resource to monitor a paging channel of the second network for paging requests. During the sleep state, the modem stack may power off most processes and components, including the associated RF resource. In some networks, such as GSM networks, the duration of time in the wake-up period that may be used to monitor/decode messages on the paging channel may be around 6 ms. The duration of a complete power-saving mode cycle (e.g., DRX cycle), measured as the interval between the start of consecutive wake-up periods, may typically be 470 ms. Similarly, the paging cycle in such embodiments (e.g., the interval between the start of consecutive scheduled page decode/monitoring times) may typically also be 470 ms.

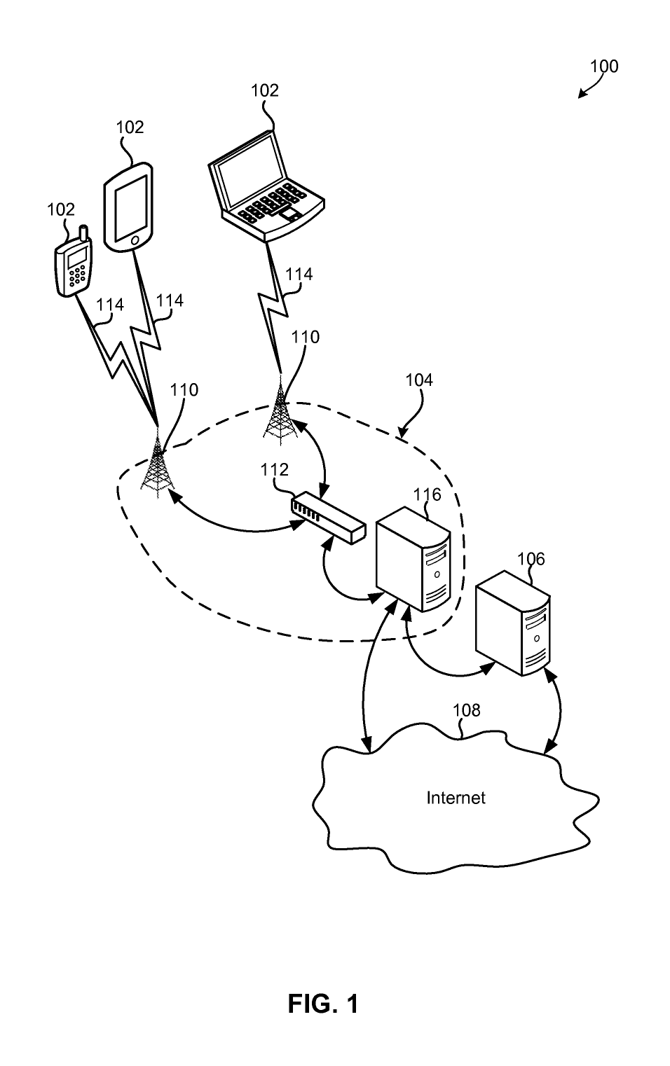

Various embodiments may be implemented within a variety of communication systems, such as the example communication system 100 illustrated in FIG. 1. The communication system 100 may include one or more wireless devices 102, a telephone network 104, and network servers 106 coupled to the telephone network 104 and to the Internet 108. In some embodiments, the network server 106 may be implemented as a server within the network infrastructure of the telephone network 104.

A typical telephone network 104 includes a plurality of cell base stations 110 coupled to a network operations center 112, which operates to connect voice and data calls between the wireless devices 102 (e.g., tablets, laptops, cellular phones, etc.) and other network destinations, such as via telephone land lines (e.g., a POTS network, not shown) and the Internet 108. The telephone network 104 may also include one or more servers 116 coupled to or within the network operations center 112 that provide a connection to the Internet 108 and/or to the network servers 106. Communications between the wireless devices 102 and the telephone network 104 may be accomplished via two-way wireless communication links 114, such as GSM, UMTS, EDGE, 4G, 3G, CDMA, TDMA, LTE, and/or other communication technologies.

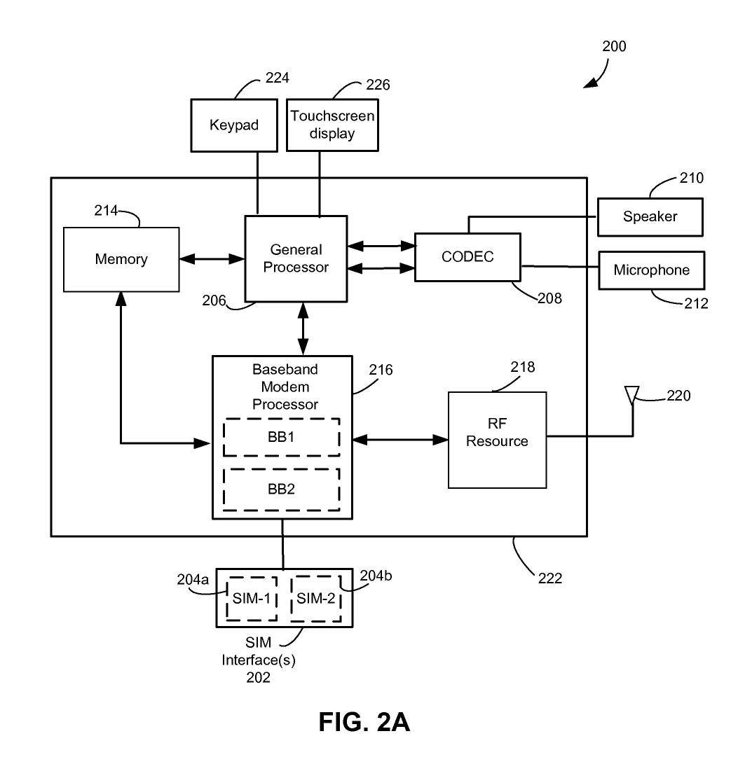

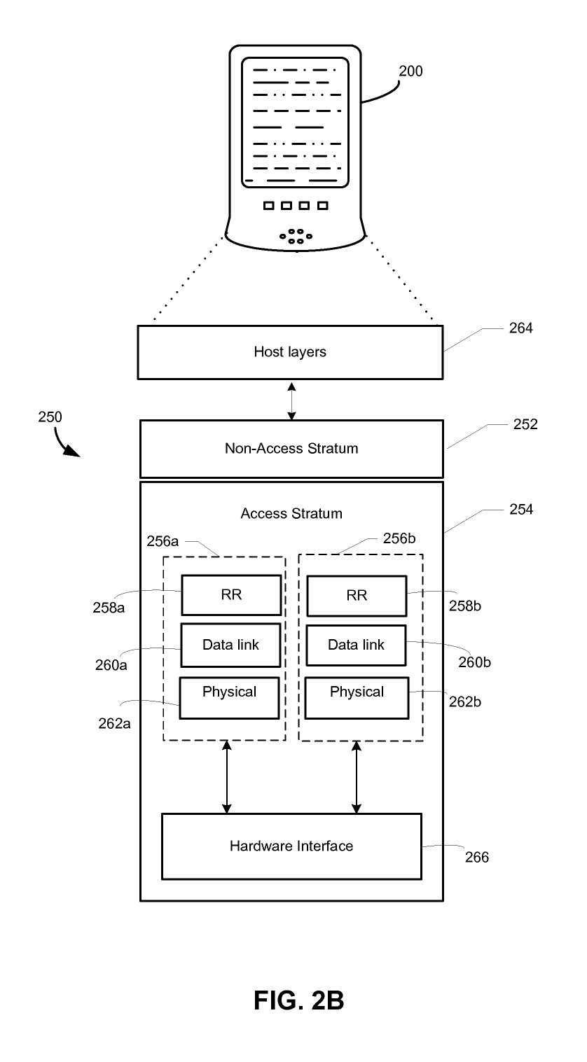

FIG. 2A is a functional block diagram of an example wireless communication device 200 that is suitable for implementing various embodiments. According to various embodiments, the wireless device 200 may be similar to one or more of the wireless devices 102 described with reference to FIG. 1. With reference to FIGS. 1-2A, in various embodiments, the wireless device 200 may be a single-SIM device, or a multi-SIM device, such as a dual-SIM device. In an example, the wireless device 200 may be a dual-SIM dual-active (DSDA) device or a dual-SIM dual-standby (DSDS) device. The wireless device 200 may include at least one SIM interface 202, which may receive a first SIM (SIM-1) 204a that is associated with a first subscription. In some embodiments, the at least one SIM interface 202 may be implemented as multiple SIM interfaces 202, which may receive at least a second SIM (SIM-2) 204b that is associated with at least a second subscription.

A SIM in various embodiments may be a Universal Integrated Circuit Card (UICC) that is configured with SIM and/or USIM applications, enabling access to GSM and/or UMTS networks. The UICC may also provide storage for a phone book and other applications. Alternatively, in a CDMA network, a SIM may be a UICC removable user identity module (R-UIM) or a CDMA subscriber identity module (CSIM) on a card.

Each SIM 204a, 204b may have a CPU, ROM, RAM, EEPROM and I/O circuits. One or more of the first SIM 204a and second SIM 204b used in various embodiments may contain user account information, an IMSI a set of SIM application toolkit (SAT) commands and storage space for phone book contacts. One or more of the first SIM 204a and second SIM 204b may further store home identifiers (e.g., a System Identification Number (SID)/Network Identification Number (NID) pair, a Home PLMN (HPLMN) code, etc.) to indicate the SIM network operator provider. An Integrated Circuit Card Identity (ICCID) SIM serial number may be printed on one or more SIM 204 for identification.

The wireless device 200 may include at least one controller, such as a general-purpose processor 206, which may be coupled to a coder/decoder (CODEC) 208. The CODEC 208 may in turn be coupled to a speaker 210 and a microphone 212. The general purpose processor 206 may also be coupled to at least one memory 214. The memory 214 may be a non-transitory tangible computer readable storage medium that stores processor-executable instructions. For example, the instructions may include routing communication data relating to a subscription though a corresponding baseband-RF resource chain. The memory 214 may store operating system (OS), as well as user application software and executable instructions.

The general purpose processor 206 and memory 214 may each be coupled to at least one baseband-modem processor 216. Each SIM 204a, 204b in the wireless device 200 may be associated with a baseband-RF resource chain that includes at least one baseband-modem processor 216 and at least one RF resource 218. In some embodiments, the wireless device 200 may be a DSDS device, with both SIMs 204a, 204b sharing a single baseband-RF resource chain that includes the baseband-modem processor 216 and RF resource 218. In some embodiments, the shared baseband-RF resource chain may include, for each of the first SIM 204a and the second SIM 204b, separate baseband-modem processor 216 functionality (e.g., BB1 and BB2). The RF resource 218 may be coupled to at least one antenna 220, and may perform transmit/receive functions for the wireless services associated with each SIM 204a, 204b of the wireless device 200. The RF resource 218 may implement separate transmit and receive functionalities, or may include a transceiver that combines transmitter and receiver functions.

In particular embodiments, the general purpose processor 206, memory 214, baseband-modem processor 216, and RF resource 218 may be included in a system-on-chip device 222. The first and second SIMs 204a, 204b and their corresponding interface(s) 202 may be external to the system-on-chip device 222. Further, various input and output devices may be coupled to components of the system-on-chip device 222, such as interfaces or controllers. Example user input components suitable for use in the wireless device 200 may include, but are not limited to, a keypad 224 and a touchscreen display 226.

In some embodiments, the keypad 224, touchscreen display 226, microphone 212, or a combination thereof, may perform the function of receiving the request to initiate an outgoing call. For example, the touchscreen display 226 may receive a selection of a contact from a contact list or receive a telephone number. In another example, either or both of the touchscreen display 226 and microphone 212 may perform the function of receiving a request to initiate an outgoing call. For example, the touchscreen display 226 may receive selection of a contact from a contact list or to receive a telephone number. As another example, the request to initiate the outgoing call may be in the form of a voice command received via the microphone 212. Interfaces may be provided between the various software modules and functions in the wireless device 200 to enable communication between them, as is known in the art.

Referring to FIGS. 1-2B, wireless device 200 may have a layered software architecture 250 to communicate over access networks associated with SIMs. The software architecture 250 may be distributed among one or more processors, such as baseband-modem processor 216. The software architecture 250 may also include a Non Access Stratum (NAS) 252 and an Access Stratum (AS) 254. The NAS 252 may include functions and protocols to support traffic and signaling between SIMs of the wireless device 200 (e.g., first SIM/SIM-1 204a, second SIM/SIM-2 204b) and their respective core networks. The AS 254 may include functions and protocols that support communication between the SIMs (e.g., first SIM 204a, second SIM 204b) and entities of their respective access networks (such as a MSC if in a GSM network).

In the multi-SIM wireless communication device 200, the AS 254 may include multiple protocol stacks, each of which may be associated with a different SIM. For example, the AS 254 may include protocol stacks 256a, 256b, associated with the first and second SIMs 204a, 204b, respectively. Although described below with reference to GSM-type communication layers, protocol stacks 256a, 256b may support any of variety of standards and protocols for wireless communications. Each protocol stack 256a, 256b may respectively include Radio Resource management (RR) layers 258a, 258b. The RR layers 258a, 258b may be part of Layer 3 of a GSM signaling protocol, and may oversee the establishment of a link between the wireless device 200 and associated access networks. In the various embodiments, the NAS 252 and RR layers 258a, 258b may perform the various functions to search for wireless networks and to establish, maintain and terminate calls.

In some embodiments, each RR layer 258a, 258b may be one of a number of sub-layers of Layer 3. Other sub-layers may include, for example, connection management (CM) sub-layers (not shown) that route calls, select a service type, prioritize data, perform QoS functions, etc.

Residing below the RR layers 258a, 258b, the protocol stacks 256a, 256b may also include data link layers 260a, 260b, which may be part of Layer 2 in a GSM signaling protocol. The data link layers 260a, 260b may provide functions to handle incoming and outgoing data across the network, such as dividing output data into data frames and analyzing incoming data to ensure the data has been successfully received. In some embodiments, each data link layer 260a, 260b may contain various sub-layers (e.g., media access control (MAC) and logical link control (LLC) layers (not shown)). Residing below the data link layers 260a, 260b, the protocol stacks 256a, 256b may also include physical layers 262a, 262b, which may establish connections over the air interface and manage network resources for the wireless device 200.

While the protocol stacks 256a, 256b provide functions to transmit data through physical media, the software architecture 250 may further include at least one host layer 264 to provide data transfer services to various applications in the wireless device 200. In some embodiments, application-specific functions provided by the at least one host layer 264 may provide an interface between the protocol stacks 256a, 256b and the general processor 206. In alternative embodiments, the protocol stacks 256a, 256b may each include one or more higher logical layers (e.g., transport, session, presentation, application, etc.) that provide host layer functions. In some embodiments, the software architecture 250 may further include in the AS 254 a hardware interface 266 between the physical layers 262a, 262b and the communication hardware (e.g., one or more RF resource).

In various embodiments, the protocol stacks 256a, 256b of the layered software architecture may be implemented to allow modem operation using information provisioned on multiple SIMs. Therefore, a protocol stack that may be executed by a baseband-modem processor is interchangeably referred to herein as a modem stack.

Although described below with reference to UMTS-type and GSM-type communication layers, the modem stacks in various embodiments may support any of a variety of current and/or future protocols for wireless communications. For examples, the modem stacks in various embodiments may support networks using other radio access technologies described in 3GPP standards (e.g., Long Term Evolution (LTE), etc.), 3GPP2 standards (e.g., 1×RTT/CDMA2000, Evolved Data Optimized (EVDO), Ultra Mobile Broadband (UMB), etc.) and/or IEEE standards Worldwide Interoperability for Microwave Access (WiMAX), Wi-Fi, etc.).

For clarity, while the techniques and embodiments described herein relate to a wireless device configured with at least one WCDMA/UMTS subscription, the embodiment techniques may be extended to subscriptions on other radio access networks (e.g., cdma2000, GSM, EVDO, LTE, etc.).

In a conventional WCDMA/UMTS system, a wireless device may attempt to send information to a base station of a network by utilizing an uplink transport channel (e.g., the RACH or the Common Packet Channel (CPCH)). For example, in order for a wireless device/modem stack associated with a SIM (e.g., first SIM) in the wireless device to initiate a communication to another wireless device (“target device”), the wireless device may request a connection to the network associated with the first SIM by performing a RACH procedure.

The RACH is a shared uplink transport channel carried by a corresponding physical channel (i.e., physical RACH (PRACH)). Use of the RACH typically includes various signaling purposes, such as registering a wireless device to the network after power-on, transitioning between different states/modes (i.e., radio resource control (RRC) states in UMTS), performing location updates, and initiating a communication to a target wireless device, etc. The RACH procedure starts by the wireless device transmitting a first preamble to a base station at an initial transmission power (P₀), which may be calculated by the wireless device based on a current channel environment. The wireless device may monitor for reception of a positive acknowledgement from the base station. Such acknowledgement is typically an acquisition indicator (AI) that is sent from the base station on an acquisition indicator channel (AICH).

If no acknowledgment/AI is detected on the AICH within a predetermined time period τp-a, (e.g., lasting the duration of 1.5-2.5 PRACH access slots), the wireless device employs a process of ramping up the transmit power in steps (i.e., open-loop power control). That is, the wireless device retransmits the preamble with the transmission power increased by one power increment/step (ΔP). In various embodiments, the power increment between successive preamble retransmissions may be 1 dBm or a multiple of 1 dBm, and may be identified by the device based on information read from one or more SIBs received from the base station. Therefore, the next preamble may be sent at a transmission power P₁ that equals P₀+ΔP. In various embodiments, following the expiration of time period τp-a, the preamble retransmission may occur after another predetermined time period τp-p (e.g., lasting the duration of 3-4 PRACH access slots). With reference to a preamble, the terms “transmission” and “retransmission” are used interchangeably herein to describe any of one or more bursts sent during the RACH preamble cycle of the same RACH procedure.

In various embodiments, a maximum number of permitted preamble retransmissions, as well as a maximum amount of time permitted for the entire RACH procedure, including sending the RACH message, may be configured by the network. Examples of values that may be used for the maximum number of permitted preamble retransmissions include, but are not limited to, 16, 32, 64, etc., while an example value that may be used for the maximum amount of time permitted for the RACH procedure is 100 ms.

If the preamble retransmissions reach the maximum number of permitted preamble retransmissions, the wireless device may cancel the RACH procedure. Following cancellation after which a new RACH procedure may be initiated following a back-off timer triggered by a data link layer (or sublayer e.g., the media access control (MAC) sublayer)) of the first SIM modem stack associated with the first SIM.

Upon detecting on the AICH that a positive acknowledgment, such as an AI, has been received from the base station, the wireless device typically sends a RACH message to the base station. In various embodiments, the duration of the RACH message may be 10 ms or 20 ms, depending on whether the RACH message is one or two RACH radio frames.

As discussed, in a DSDS device in which the SIMs are configured to implement discontinuous reception (DRX), the RF resource is typically used to support both SIMs when both are in idle mode, but one SIM at a time when at least one SIM transitions out of idle mode. Conventionally, the DSDS device will still monitor system information from, and maintain a connection with, the serving network of the second SIM by implementing idle-DRX mode on the modem stack associated with the second SIM. That is, the RF resource periodically tunes away from communication on the first SIM in order to decode a paging channel associated with the second SIM. If the tune-away period overlaps with a RACH procedure for the first SIM, the entire RACH is cancelled, and the data link layer back-off timer is triggered to delay starting a new RACH procedure. In a WCDMA/UMTS network, such a back-off may typically last around 200-300 ms. Since, as discussed, the tune-away period occurs during every DRX cycle for the second SIM (e.g., every 470 ms in GSM), overlaps between the RACH and the tune-away period can be frequent, in particular during an active data session on the first SIM. As a result, the monitoring of the paging channel on the network associated with the second SIM may cause degradation of throughput and/or round-trip time (RTT) for communications on the modem stack associated with the first SIM

In the various embodiments, an adaptive RACH procedure may be implemented in order to mitigate the harm to the throughput and/or RTT on the modem stack associated with the first SIM, while maintaining page performance for the second SIM. In particular, the adaptive RACH procedure may involve detecting that an upcoming tune-away period will overlap with the ongoing RACH procedure, and upon such tune-away of the RF resource, triggering a virtual preamble sequence. That is, when the shared RF resource tunes to the network associated with the second SIM, transmission of preambles at the physical layer is paused at the physical layer, thereby avoiding triggering the typical back-off timer in the data link layer. Further, during the tune-away period, a virtual preamble scheduler continues the transmit power step-ups after each duration of tp-p. In this manner, when the tune-away period is over and the physical layer activity resumed, the next preamble is transmitted at the same power level it would have reached without the tune-away.

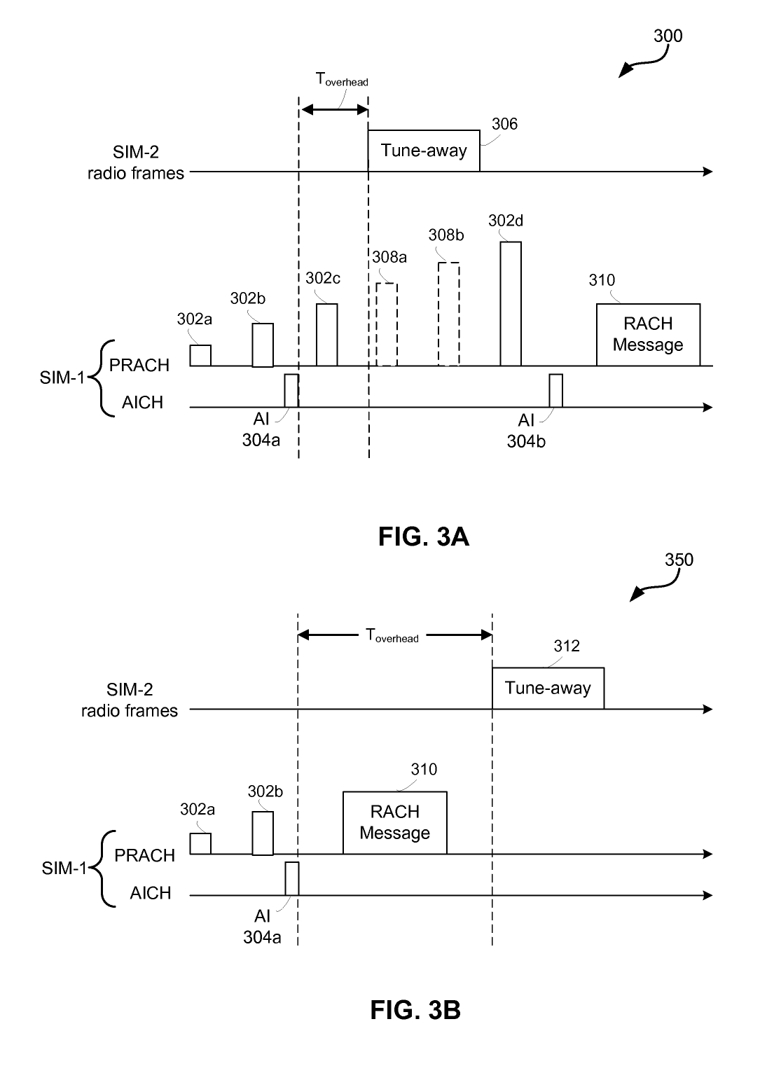

Examples using the adaptive RACH procedure in are shown in the timelines in FIGS. 3A and 3B. With reference to FIGS. 1-3B, timelines 300, 350 include representative timing of an uplink PRACH and downlink AICH for a network supported by the first SIM (“SIM-1”). The timelines 300, 350 also include representative timing for the radio frames involved in monitoring the paging channel of a network supported by the second SIM (“SIM-2”).

In some embodiments, as shown in the timeline 300, a wireless device (e.g., 102, 200) without a dedicated traffic channel may attempt to access the network supported by the first SIM (i.e., first network) by transmitting to a base station (e.g., 110) a first preamble 302a at an initial transmission power P₀. In various embodiments, the initial transmission power may be calculated based on parameters that reflect the current channel environment, including transmission power of a Common Pilot Channel (CPICH), the received signal code power strength (CPICH_RSCP), and the uplink interference.

The CPICH_RSCP value may be measured by the wireless device, while the CPICH value and uplink interference value may be obtained by reading one or more SIB in a system information message broadcast by a base station of the first network. The system information message may include other RACH-related information, such as the maximum number of permitted preamble retransmissions and the preamble power increment (ΔP), discussed above. In various embodiments, the RACH message may be the first of a series of channel establishment messages exchanged between the wireless device and the base station in order for the wireless device perform a communication or signaling with the base station.

In the PRACH channel, two 10 ms PRACH radio frames may be joined to form a 20 ms RACH frame of 15 access slots. The length of the RACH message may be 10 ms, corresponding to one radio frame, or 20 ms, corresponding to two radio frames.

As shown in timeline 300, if no acknowledgement (e.g., an AI) is received within the predetermined time period of tp-a following the preamble, the preamble may be retransmitted after expiration of another predetermined time τp-p. In the various embodiments, the preamble retransmission may have a transmission power that is increased by one increment of ΔP. That is, the first preamble retransmission 302b may be sent with a transmission power P₁ that equals P₀+ΔP dB.

An acknowledgement/AI may be received within the predetermined time period following a preamble transmission, such as AI 304a following the first preamble retransmission 302b. In various embodiments, if no acknowledgement/AI is received, or if the amount of time between receipt of the acknowledgment/AI 304a and an upcoming tune-away period 306 (i.e., T_{overhead}) is less than the duration of time for sending the RACH message (e.g., 10 ms or 20 ms), preamble retransmissions may continue in a step-wise manner that increases transmission power by ΔP with each successive retransmission. For example, after the first preamble retransmission 302b, following expiration of time τp-p, a second preamble retransmission 302c may be sent with a transmission power P₂ that equals P₁+ΔP dB.

During the tune-away period 306, the RF resource may be tuned to a different network in order to allow paging channel decode operations by the modem sack associated with the second SIM. The modem stack associated with the first SIM may suspend the transmission of preambles over the radio link during the tune-away and instead perform a virtual preamble sequence. In particular, during the tune-away period, a virtual preamble scheduler may count the preambles that would have been sent after each interval τp-p, still increasing the transmission power by ΔP with each successive retransmission. For example, the virtual preamble scheduler, which may be implemented as a control module by the wireless device processor (e.g., 206), may record a third virtual preamble retransmission 308a and fourth virtual preamble retransmission 308b as being sent at transmission powers (P₃ and P₄) calculated as P₂+ΔP dBm and P₃+ΔP dB, respectfully, even though transmission activity has been paused at the physical layer.

Once the tune-away period 306 has ended and the RF resource is tuned again to the network in which the wireless device is seeking access, preamble retransmissions may resume at the physical layer, starting at a power level that is increased over that of the last virtual preamble retransmission recorded by the virtual preamble scheduler by. For example, the fifth preamble retransmission 302d may be sent to the base station almost immediately upon resuming the normal physical layer activity by the modem stack associated with the first SIM. Since the transmit power of the fifth preamble retransmission 302d is many power increments higher than the transmit power prior to the tune-away period, the likelihood of receiving an acknowledgement (e.g., an AI) on the AICH in response to the fifth preamble retransmission 302d may be very high. When an acknowledgement/AI 304b is received, such as within the predetermined time tp-a after the fifth preamble retransmission 302d, the RACH message may be transmitted to the base station on the PRACH.

In some embodiments, as shown in the timeline 350, the T_{overhead} time between receipt of the acknowledgement/AI 304a and an upcoming tune-away period 312 (i.e., T_{overhead}) may be greater than the duration of the RACH message 310 (e.g., 10 ms or 20 ms), thereby allowing immediate transmission of the RACH message after the fixed tp-m time.

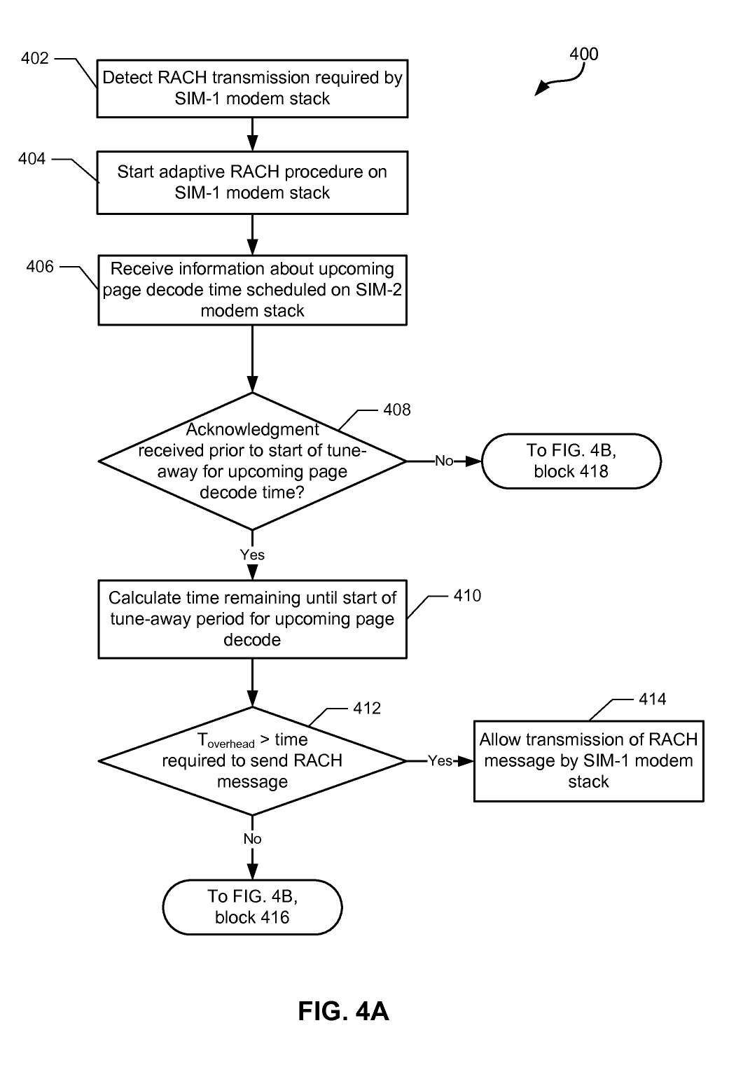

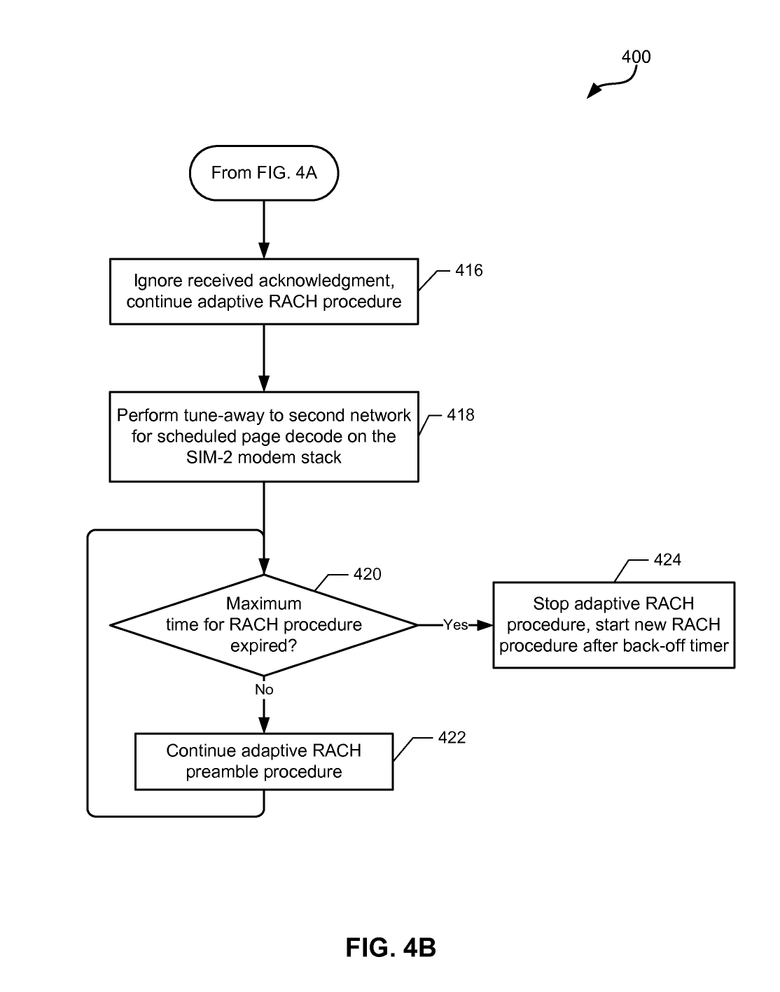

FIGS. 4A and 4B illustrate a method 400 for avoiding delay in accessing a first network supported by a first SIM of while maintaining page decode success on a second network supported by a second SIM of a multi-SIM multi-standby (e.g., DSDS) wireless device (e.g., 102, 200 in FIGS. 1-2) according to some embodiments. With reference to FIGS. 1-4B, the multi-SIM multi-standby device may be configured with a single shared RF resource (e.g., 218). In various embodiments, the operations of the method 400 may be implemented by one or more processors of the wireless device, such as a general purpose processor (e.g., 206) and/or baseband-modem processor (e.g., 216), or a separate controller (not shown) that may be coupled to memory (e.g., 214) and to a baseband-modem processor.

In block 402, the wireless device processor may detect that a modem stack associated with a first SIM (“SIM-1”) is performing activity in which a RACH procedure is required. For example, the wireless device processor may detect an input or other indication for the wireless device to initiate a call to a target device, or exchange data or control information with the first network. The wireless device processor may also detect that the modem stack associated with the first SIM has not been allocated any dedicated channel/resource by the first network.

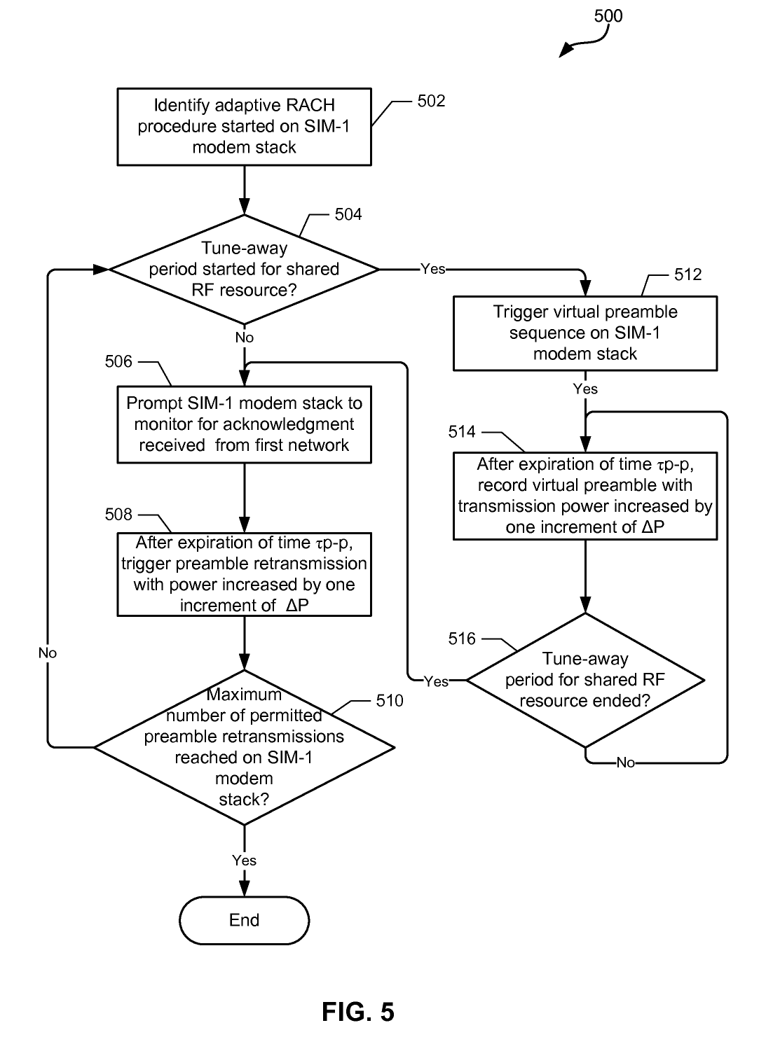

In block 404, the wireless device processor may start an adaptive RACH procedure to access the first network on the modem stack associated with the first SIM (e.g., as discussed with respect to FIG. 5). The start of the adaptive RACH procedure may involve, for example, using the shared RF resource (e.g., 218 in FIG. 2A) to send a first preamble on a PRACH at an initial transmission power to the first network.

In block 406, the wireless device processor may receive information about an upcoming activity reservation for the second SIM (“SIM-2”), such as an upcoming page decode time, to monitor a paging channel on the second network. That is, the wireless device processor may be notified of a time interval during which a paging group that includes the second SIM may receive communications (e.g., incoming calls) over the second network, indicating a time at which use of the shared RF resource will be temporarily removed from the first SIM modem stack.

The references to the first SIM/SIM-1 and the second SIM/SIM-2 are arbitrary and used merely for the purposes of describing the embodiments, and the wireless device processor may assign any indicator, name or other designation to differentiate the SIMs and associated modem stacks. Further, embodiment methods apply the same regardless of which SIM is involved in an active voice call.

In determination block 408, the wireless device processor may determine whether an acknowledgment is received (e.g., an AI on the AICH) prior to the start of the tune-away period for the upcoming page decode time. In response to determining that an acknowledgment for the modem stack associated with the first SIM is received prior to the start of the tune-away period for the upcoming page decode time (i.e., determination block 408=“Yes”), in block 410 the wireless device processor may calculate the time remaining (T_{overhead}) until the start of the tune-away period for the upcoming page decode on the second network.

In various embodiments, T_{overhead} may be calculated as the amount of time between the end of the received acknowledgment and the beginning of the scheduled page decode time or the beginning of a tear down of the radio link for the first network in preparation of switching the RF resource to a different frequency. In various embodiments, the tear down of the first network radio link may begin a short time before the actual page decode time, and may be configured with sufficient time to also allow for establishment of a new link on the second network.

In determination block 412, the wireless device processor may determine whether the calculated T_{overhead} is greater than the time required to transmit the RACH message that is the subject of the ongoing adaptive RACH procedure. As discussed, transmission of the RACH message may take 10 ms or 20 ms, depending on whether one or two RACH radio frames are to be sent to the first network. In response to determining that the calculated T_{overhead} is greater than the time required to transmit the RACH message (i.e., determination block 412=“Yes”), in block 414 the wireless device processor may allow the modem stack associated with the first SIM to send the RACH message at the next opportunity on the PRACH, according to the normal RACH procedure. That is, the RACH message may be transmitted before the start of the tune-away period (e.g., as shown in FIG. 3B), thereby stopping the adaptive RACH procedure RACH procedure.

In response to determining that the calculated T_{overhead} is not greater than the time required to transmit the RACH message (i.e., determination block 412=“No”), the wireless device processor may proceed to block 416 (FIG. 4B). In block 416, the wireless device processor may ignore the acknowledgment received by the first network, continuing the adaptive RACH procedure as if no acknowledgment was received.

In continuing the adaptive RACH procedure and/or in response to determining that no acknowledgement/AI was received on the modem stack associated with the first SIM prior to the start of the tune-away period (i.e., determination block 408=“No”), the wireless device processor may perform the tune-way to the second network for the scheduled page decode by the modem stack associated with the second SIM in block 418. Following the end of the tune-away to the second network, the wireless device processor may determine whether a maximum RACH procedure time has expired in determination block 420. As discussed, the maximum time permitted to continue monitoring for reception of an acknowledgement/AI for a particular RACH message may be set by the first network, and received by the wireless device in system information from a base station of the first network. In some embodiments, the value set by the first network for the maximum time may be 100 ms. In response to determining that the maximum RACH procedure time has not expired (i.e., determination block 420=“No”), the wireless device processor may continue the adaptive RACH procedure in block 422. The wireless device processor may repeat determination block 420 and continue the adaptive RACH procedure in block 422 so long as the maximum RACH preamble procedure time has not expired (i.e., determination block 420=“No”)

In response to determining that the maximum RACH procedure time has expired (i.e., determination block 420=“Yes”), the wireless device processor may stop the adaptive RACH procedure in block 424, with a new RACH procedure to start after expiration of a back-off timer triggered in the data link layer (e.g., 260a in FIG. 2B). As discussed, the back-off timer triggered in the data link layer may be around 300 ms.

FIG. 5 illustrates an adaptive RACH procedure that may be implemented in the method 400 (FIGS. 4A, 4B) on a multi-SIM multi-standby (e.g., DSDS) wireless device according to various embodiments. With reference to FIGS. 1-5, the operations of method 500 in FIG. 5 may be implemented by one or more processors of the wireless device (e.g., 102, 200), such as a general purpose processor (e.g., 206) and/or baseband-modem processor(s) (e.g., 216), or a separate controller (not shown) that may be coupled to memory (e.g., 214) and to a baseband-modem processor(s).

In determination block 504 of method 500, the wireless device processor may identify that an adaptive RACH procedure has been started on a modem stack associated with a first SIM (“SIM-1”). In determination block 504, the wireless device processor may determine whether a tune-away period for the shared RF resource (e.g., 218) has started. That is, the wireless device processor may determine whether use of the shared RF resource has been temporarily shifted from the modem stack associated with the first SIM to a modem stack associated with the second SIM (“SIM-2”) to decode a paging channel on a network supported by the second SIM (i.e., second network). In response to determining that the tune-away period for the shared RF resource has not started (i.e., determination block 504=“No”), the wireless device processor may prompt the modem stack associated with the first SIM to monitor for receipt of an acknowledgment from the first network (e.g., monitoring the AICH for an AI) in block 506, such as in the response to a first preamble that was sent to start the adaptive RACH procedure (e.g., block 404 in FIG. 4A).

After the predetermined time τp-p, the wireless device processor may trigger a preamble retransmission on the modem stack associated with the first SIM at an increased transmission power (i.e., power step-up by one increment of ΔP) in block 508. In some embodiments, the duration of the predetermined time period ip-p (i.e., timing between successive preamble transmissions) may be configured by the first network, and may be the length of around of 3-4 PRACH access slots.

In determination block 510, the wireless device processor may determine whether a maximum number of permitted preamble retransmissions has been reached on the modem stack associated with the first SIM. As discussed, the maximum number of permitted preamble retransmissions for monitoring for reception of an acknowledgement/AI for a RACH message may be set by the first network, and received by the wireless device in system information broadcast by a base station of the first network. Example maximum number values may include 16 retransmissions, 32 retransmissions, etc.

In response to determining that the maximum number of permitted preamble retransmissions has been reached (i.e., determination block 510=“Yes”), the wireless device processor may end the procedure without accomplishing the RACH message transmission. In various embodiments, such end of the procedure may prompt the start of a new RACH procedure after expiration of a back-off timer triggered in the data link layer on the modem stack associated with the first SIM. In response to determining that the maximum number of permitted preamble retransmissions has not been reached (i.e., determination block 510=“No”), the wireless device processor may again determine whether the tune-away period on the shared RF resource has been started in determination block 504. The wireless device processor may repeat the method 500 so long as the tune-away period has not been started (i.e., as long as determination block 504=“No”).

In response to determining that the tune-away period for the shared RF resource has started (i.e., determination block 504=“Yes”), the wireless device processor may trigger a virtual preamble sequence in block 512, causing the modem stack associated with the first SIM to pause transmission activity in the physical layer. Since the activity is not stopped, the data link layer back-off timer for a new RACH procedure is not triggered. After expiration of the predetermined time τp-p, the wireless device may record a virtual preamble with transmission power increased by one increment of ΔP in block 514. That is, no preamble is transmitted, but power level step-ups may be tracked and timed as if the preambles were being transmitted. In various embodiments, the triggering of the virtual preamble sequence, tracking, and recording of virtual preamble power step-ups may be performed by a virtual preamble scheduler, which may be a module in firmware of the wireless device processor.

In determination block 516, the wireless device processor may determine whether the tune-away period for the shared RF resource has ended. That is, the wireless device processor may determine whether use of the shared RF resource has been reallocated to the modem stack associated with the first SIM. In response to determining that the tune-away period for the shared RF resource has not ended (i.e., determination block 516=“No”), after expiration of the predetermined time τp-p, the wireless device processor may again record a virtual preamble that has a transmission power increased by one increment of ΔP in block 514. The wireless device processor may continue the virtual preamble sequence by repeating the operations in block 514 as long as the tune-away period has not ended (i.e., as long as determination block 516=“No”).

In response to determining that the tune-away period for the shared RF resource has ended (i.e., determination block 516=“Yes”), the wireless device processor may stop the virtual preamble sequence and prompt the modem stack associated with the first SIM to resume monitoring the AICH for reception of an acknowledgement (e.g., an AI) in block 506. Since the shared RF resource is again allocated to the modem stack associated with the first SIM, the physical layer activity may be resumed. In this manner, preamble retransmissions may be continued, with transmission power increased again by adding one increment of ΔP to the power level of the previous preamble transmission, which may have been an actual preamble (e.g., from block 508) or virtual preamble (i.e., from block 514).

The specific duration of a tune-away period may depend on the particular network and radio access technology enabled by the second SIM and implemented by the second network. For example, for a second SIM configured to connect to a GSM network, the RF resource release gap may be around 20 ms, centered at the page decode time may be around 6 ms, but may require around 20 ms including the establishment and teardown of radio links with the second network.

The various embodiments improve data throughput and RTT for uplink transmission on a first SIM without affecting the periodic tune-away for page decode on a second SIM. In particular, when an upcoming tune-away period will overlap with an ongoing RACH procedure on the first SIM, the wireless device processor may implement an adaptive RACH procedure that efficiently adjusts to avoid delay on either SIM when the shared RF resource is needed for activities on each associated modem stack. In some embodiments, if an AI or other acknowledgment is received from the first network in response to a preamble, and the acknowledgement/AI is received before the upcoming tune-away period, the wireless device may determine whether sufficient time is left to send the RACH message prior to the tune-away. If there is not sufficient time remaining, the adaptive RACH procedure may ignore the received acknowledgement/AI instead of transmitting the RACH message, since the RACH message would fail or delay the page decode once the scheduled tune-away period starts.

Further, if no acknowledgement/AI was received or if the acknowledgement/AI was received and ignored during the tune-away period, wireless device may track and record the expected incrementing power levels that would be applied for preamble transmissions that would have been sent but for the tune-away period. That is, using the known timing associated with retransmission following an unacknowledged preamble (i.e., no acknowledgement/AI is received within a predetermined time on the RICH) and the known power transmission increment, the wireless device may be configured to apply incremental power step-ups to the transmission power level of the last preamble before the paused RACH activity for as long as the tune-away lasts. Once the RACH activity is resumed in the physical layer, the wireless device may resume preamble retransmissions, increasing the transmission power by one power increment in relation to the level recorded for the last virtual preamble.

In this manner, the device may avoid the data link layer back-off timer that is typically triggered when a RACH is cancelled, which may be around 300 ms, and may allow the physical layer RACH activity to continue setup as if preambles had been transmitted throughout the tune-away.

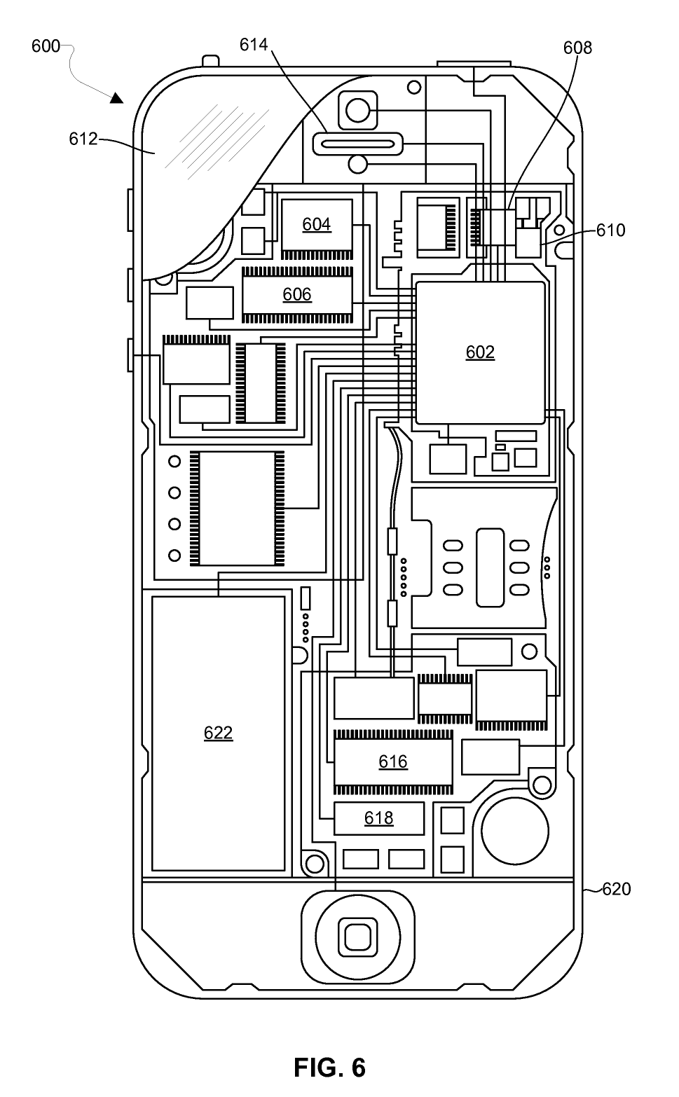

Various embodiments may be implemented in any of a variety of wireless devices, an example of which is illustrated in FIG. 6. For example, With reference to FIGS. 1-6, a wireless device 600 (which may correspond, for example, the wireless devices 102, 200 in FIGS. 1-2) may include a processor 602 coupled to a touchscreen controller 604 and an internal memory 606. The processor 602 may be one or more multicore integrated circuits (ICs) designated for general or specific processing tasks. The internal memory 606 may be volatile or non-volatile memory, and may also be secure and/or encrypted memory, or unsecure and/or unencrypted memory, or any combination thereof.

The touchscreen controller 604 and the processor 602 may also be coupled to a touchscreen panel 612, such as a resistive-sensing touchscreen, capacitive-sensing touchscreen, infrared sensing touchscreen, etc. The wireless device 600 may have one or more radio signal transceivers 608 (e.g., Peanut®, Bluetooth®, Zigbee®, Wi-Fi, RF radio) and antennae 610, for sending and receiving, coupled to each other and/or to the processor 602. The transceivers 608 and antennae 610 may be used with the above-mentioned circuitry to implement the various wireless transmission protocol stacks and interfaces. The wireless device 600 may include a cellular network wireless modem chip 616 that enables communication via a cellular network and is coupled to the processor. The wireless device 600 may include a peripheral device connection interface 618 coupled to the processor 602. The peripheral device connection interface 618 may be singularly configured to accept one type of connection, or multiply configured to accept various types of physical and communication connections, common or proprietary, such as USB, FireWire, Thunderbolt, or PCIe. The peripheral device connection interface 618 may also be coupled to a similarly configured peripheral device connection port (not shown). The wireless device 600 may also include speakers 614 for providing audio outputs. The wireless device 600 may also include a housing 620, constructed of a plastic, metal, or a combination of materials, for containing all or some of the components discussed herein. The wireless device 600 may include a power source 622 coupled to the processor 602, such as a disposable or rechargeable battery. The rechargeable battery may also be coupled to the peripheral device connection port to receive a charging current from a source external to the wireless device 600.

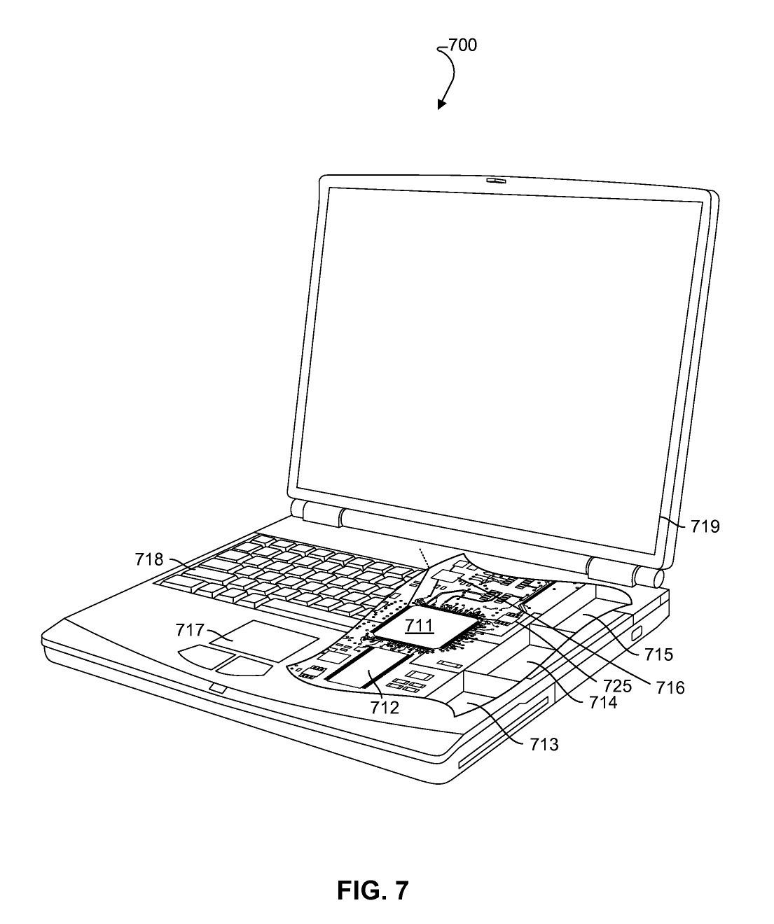

Various embodiments described above may also be implemented within a variety of personal computing devices, such as a laptop computer 700 (which may correspond, for example, the wireless devices 102, 200 in FIGS. 1-2) as illustrated in FIG. 7. With reference to FIGS. 1-7, many laptop computers include a touchpad touch surface 717 that serves as the computer's pointing device, and thus may receive drag, scroll, and flick gestures similar to those implemented on wireless computing devices equipped with a touch screen display and described above. The laptop computer 700 will typically include a processor 711 coupled to volatile memory 712 and a large capacity nonvolatile memory, such as a disk drive 713 of Flash memory. The laptop computer 700 may also include a floppy disc drive 714 and a compact disc (CD) drive 715 coupled to the processor 711. The laptop computer 700 may also include a number of connector ports coupled to the processor 711 for establishing data connections or receiving external memory devices, such as a USB or FireWire® connector sockets, or other network connection circuits for coupling the processor 711 to a network. In a notebook configuration, the computer housing includes the touchpad touch surface 717, the keyboard 718, and the display 719 all coupled to the processor 711. Other configurations of the computing device may include a computer mouse or trackball coupled to the processor (e.g., via a USB input) as are well known, which may also be use in conjunction with various embodiments.

The processors 602 and 711 may be any programmable microprocessor, microcomputer or multiple processor chip or chips that can be configured by software instructions (applications) to perform a variety of functions, including the functions of various embodiments described above. In some devices, multiple processors may be provided, such as one processor dedicated to wireless communication functions and one processor dedicated to running other applications. Typically, software applications may be stored in the internal memory 606, 712 and 713 before they are accessed and loaded into the processors 602 and 711. The processors 602 and 711 may include internal memory sufficient to store the application software instructions. In many devices, the internal memory may be a volatile or nonvolatile memory, such as flash memory, or a mixture of both. For the purposes of this description, a general reference to memory refers to memory accessible by the processors 602, 711, including internal memory or removable memory plugged into the device and memory within the processor 602 and 711, themselves.

The foregoing method descriptions and the process flow diagrams are provided merely as illustrative examples and are not intended to require or imply that the steps of various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

While the terms “first” and “second” are used herein to describe data transmission associated with a SIM and data receiving associated with a different SIM, such identifiers are merely for convenience and are not meant to limit the various embodiments to a particular order, sequence, type of network or carrier.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary embodiment, the functions described may be implemented in hardware, software, firmware, or any combination thereof. If implemented in software, the functions may be stored as one or more instructions or code on a non-transitory computer-readable medium or non-transitory processor-readable medium. The steps of a method or algorithm disclosed herein may be embodied in a processor-executable software module which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A method of improving data throughput and page performance of a multi-subscriber identification module (SIM) wireless communication device having at least a first SIM and a second SIM associated with a shared radio frequency (RF) resource, the method comprising:
detecting when a random access channel (RACH) procedure required on a modem stack associated with the first SIM in order to access a first network will coincide with a scheduled tune-away period for the shared RF resource corresponding to a reservation for activity on a second network supported by the second SIM;
monitoring for reception of an acknowledgment for the modem stack associated with the first SIM in response to preambles transmitted on a physical RACH (PRACH) to the first network using the shared RF resource;
periodically transmitting preambles to the first network with increasing transmission power until an acknowledgment is received or the scheduled tune-away period starts, wherein each preamble is transmitted at a transmission power equal to a sum of a preceding preamble transmission power and a power increment value; and
in response to the scheduled tune-away period starting before an acknowledgment is received:
pausing transmission of additional preambles; and
recording virtual preambles for the first network.

2. The method of claim 1, further comprising:
determining whether the scheduled tune-away period has ended; and
in response to determining that the scheduled tune-away period has ended:
stopping recording of the virtual preambles; and
resuming transmission of additional preambles based on the recorded virtual preambles from the tune-away period.

3. The method of claim 1, wherein the preceding preamble transmission power comprises a power value corresponding to a more recent of a last transmitted additional preamble and a last recorded virtual preamble.

4. The method of claim 1, wherein recording the virtual preambles for the first network comprises, for each virtual preamble:
waiting a predetermined period of time; and
recording a transmission power, wherein the transmission power comprises a sum of the power increment value and a power value corresponding to a more recent of a last transmitted additional preamble and a last recorded virtual preamble.

5. The method of claim 4, wherein an initial transmission power, the power increment value, and the predetermined period of time are identified in system information received from a base station of the first network.

6. The method of claim 1, further comprising:
calculating an overhead time for the received acknowledgment in response to receiving an acknowledgment for the modem stack associated with the first SIM prior to starting the tune-away period, wherein the overhead time comprises a duration of time between the received acknowledgment and a start of the scheduled tune-away period; and
determining whether the calculated overhead time is longer than a time required to transmit a RACH message to the first network.

7. The method of claim 6, wherein the time required to transmit the RACH message to the first network comprises one of 10 ms and 20 ms.

8. The method of claim 6, further comprising sending the RACH message to the first network before the start of the scheduled tune-away period in response to determining that the calculated overhead time is longer than the time required to transmit the RACH message to the first network.

9. The method of claim 6, further comprising ignoring the received acknowledgment in response to determining that the calculated overhead time is longer than the time required to transmit the RACH message to the first network.

10. The method of claim 1, further comprising detecting that a RACH procedure is required on a modem stack associated with the first SIM by detecting that a radio resource control (RRC) connection setup is requested on a modem stack associated with the first SIM.

11. The method of claim 1, further comprising detecting that a RACH is required to access the first network supported by the first SIM on the modem stack associated with the first SIM by:
detecting that data needs to be sent to the modem stack associated with the first SIM; and
detecting that a dedicated physical channel in an uplink is not allocated in to the first SIM.

12. The method of claim 1, wherein periodically transmitting preambles to the first network with increasing transmission power until an acknowledgment is received or the scheduled tune-away period starts comprises:
transmitting a first preamble to the first network;
determining whether a preset waiting time since the transmission of the first preamble has expired;
transmitting a second preamble in response to determining that the preset waiting time has expired; and
repeating the operations of determining whether a preset waiting time since the transmission of a preceding preamble has expired and transmitting another preamble in response to expiration of the preset waiting time until the acknowledgment is received.

13. The method of claim 12, further comprising:
determining, based on a count of transmitted preambles, whether a maximum number of permitted preamble transmissions has been reached, wherein the maximum number of permitted preamble transmissions is identified from system information received from a base station of the first network; and
stopping transmission of preambles in response to determining that the maximum number of permitted preamble transmissions has been reached.

14. The method of claim 1, wherein:
the reservation for activity on the second network comprises a page decode time for the second SIM; and
monitoring for reception of an acknowledgment comprises monitoring an acquisition indicator channel (AICH), wherein the acknowledgment comprises an acquisition indicator (AI).

15. A wireless communication device, comprising:
a radio frequency (RF) resource configured to connect to at least one of a first subscriber identity module (SIM) and a second SIM; and
a processor coupled to the RF resource and configured with processor-executable instructions to:
detect when a random access channel (RACH) procedure required on a modem stack associated with the first SIM in order to access a first network will coincide with a scheduled tune-away period for the RF resource corresponding to a reservation for activity on a second network supported by the second SIM;
monitor for reception of an acknowledgment for the modem stack associated with the first SIM in response to preambles transmitted on a physical RACH (PRACH) to the first network using the RF resource;
periodically transmit preambles to the first network with increasing transmission power until an acknowledgement is received or the scheduled tune-away period starts, wherein each preamble is transmitted at a transmission power equal to a sum of a preceding preamble transmission power and a power increment value; and
in response to the scheduled tune-away period starting before an acknowledgement is received:
pause transmission of additional preambles; and
record virtual preambles for the first network.

16. The wireless communication device of claim 15, wherein the processor is further configured with processor-executable instructions to:
determine whether the scheduled tune-away period has ended; and
in response to determining that the scheduled tune-away period has ended:
stop recording of the virtual preambles; and
resume transmission of additional preambles based on the recorded virtual preambles from the tune-away period.

17. The wireless communication device of claim 15, wherein the preceding preamble transmission power comprises a power value corresponding to a more recent of a last transmitted additional preamble and a last recorded virtual preamble.

18. The wireless communication device of claim 15, wherein the processor is further configured with processor-executable instructions to record the virtual preambles for the first network by, for each virtual preamble:
waiting a predetermined period of time; and
recording a transmission power, wherein the transmission power comprises a sum of the power increment value and a power value corresponding to a more recent of a last transmitted additional preamble and a last recorded virtual preamble.

19. The wireless communication device of claim 18, wherein an initial transmission power, the power increment value, and the predetermined period of time are identified in system information received from a base station of the first network.

20. The wireless communication device of claim 15, wherein the processor is further configured with processor-executable instructions to:
calculate an overhead time for the received acknowledgement in response to receiving an acknowledgement for the modem stack associated with the first SIM prior to starting the tune-away period, wherein the overhead time comprises a duration of time between the received acknowledgement and a start of the scheduled tune-away period; and
determine whether the calculated overhead time is longer than a time required to transmit a RACH message to the first network.

21. The wireless communication device of claim 20, wherein the time required to transmit the RACH message to the first network comprises one of 10 ms and 20 ms.

22. The wireless communication device of claim 20, wherein the processor is further configured with processor-executable instructions to send the RACH message to the first network before the start of the scheduled tune-away period in response to determining that the calculated overhead time is longer than the time required to transmit the RACH message to the first network.

23. The wireless communication device of claim 20, wherein the processor is further configured with processor-executable instructions to ignore the received acknowledgement in response to determining that the calculated overhead time is not longer than the time required to transmit the RACH message to the first network.

24. The wireless communication device of claim 15, wherein the processor is further configured with processor-executable instructions to detect that a RACH procedure is required on a modem stack associated with the first SIM by detecting that a radio resource control (RRC) connection setup is requested on a modem stack associated with the first SIM.

25. The wireless communication device of claim 15, wherein the processor is further configured with processor-executable instructions to detect that a RACH is required to access the first network supported by the first SIM on the modem stack associated with the first SIM by:
detecting that data needs to be sent to the modem stack associated with the first SIM; and
detecting that a dedicated physical channel in an uplink is not allocated in to the first SIM.

26. The wireless communication device of claim 15, wherein the processor is further configured with processor-executable instructions to periodically transmit preambles to the first network with increasing transmission power until an acknowledgement is received or the scheduled tune-away period starts by:
transmitting a first preamble to the first network;
determining whether a preset waiting time since the transmission of the first preamble has expired;
transmitting a second preamble in response to determining that the preset waiting time has expired; and
repeating operations of determining whether a preset waiting time since the transmission of a preceding preamble has expired and transmitting another preamble in response to expiration of the preset waiting time until the acknowledgement is received.

27. The wireless communication device of claim 26, wherein the processor is further configured with processor-executable instructions to:
determine, based on a count of transmitted preambles, whether a maximum number of permitted preamble transmissions has been reached, wherein the maximum number of permitted preamble transmissions is identified from system information received from a base station of the first network; and
stop transmission of preambles in response to determining that the maximum number of permitted preamble transmissions has been reached.

28. The wireless communication device of claim 15, wherein:
the reservation for activity on the second network comprises a page decode time for the second SIM; and
the processor is further configured with processor-executable instructions to monitor for reception of an acknowledgment by monitoring an acquisition indicator channel (AICH), wherein the acknowledgment comprises an acquisition indicator (AI).

29. A wireless communication device, comprising:
a radio frequency (RF) resource configured to connect to at least one of a first subscriber identity module (SIM) and a second SIM; and
means for detecting when a random access channel (RACH) procedure required on a modem stack associated with the first SIM in order to access a first network will coincide with a scheduled tune-away period for the RF resource corresponding to a reservation for activity on a second network supported by the second SIM;
means for monitoring for reception of an acknowledgment for the modem stack associated with the first SIM in response to preambles transmitted on a physical RACH (PRACH) to the first network using the RF resource;
means for periodically transmitting preambles to the first network with increasing transmission power until an acknowledgement is received or the scheduled tune-away period starts, wherein each preamble is transmitted at a transmission power equal to a sum of a preceding preamble transmission power and a power increment value;
means for pausing transmission of additional preambles in response to the scheduled tune-away period starting before an acknowledgement is received; and
means for recording virtual preambles for the first network.

30. A non-transitory processor-readable storage medium having stored thereon processor-executable instructions configured to cause a processor of a wireless communication device having a radio frequency (RF) resource associated with at least one of a first subscriber identity module (SIM) and a second SIM to perform operations comprising:
detecting when a random access channel (RACH) procedure required on a modem stack associated with the first SIM in order to access a first network will coincide with a scheduled tune-away period for the RF resource corresponding to a reservation for activity on a second network supported by the second SIM;
monitoring for reception of an acknowledgment for the modem stack associated with the first SIM in response to preambles transmitted on a physical RACH (PRACH) to the first network using the RF resource;
periodically transmitting preambles to the first network with increasing transmission power until an acknowledgement is received or the scheduled tune-away period starts, wherein each preamble is transmitted at a transmission power equal to a sum of a preceding preamble transmission power and a power increment value; and
in response to the scheduled tune-away period starting before an acknowledgement is received:
pausing transmission of additional preambles; and
recording virtual preambles for the first network.
